(19) United States
(12) Patent Application Publication
(10) Pub. No.: US 2018/0032695 A1
(43) Pub. Date: Feb. 1, 2018

(54) METHOD AND A SYSTEM FOR DETERMINING PLAUSIBILITY OF A CLINICAL CARE PLAN

(71) Applicant: HITACHI, LTD., Tokyo (JP)

(72) Inventors: Manikandan R, Bangalore (IN); Sarath P R, Bangalore (IN); Saima MOHAN, Bangalore (IN)

(73) Assignee: HITACHI, LTD., Tokyo (JP)

(21) Appl. No.: 15/654,845

(22) Filed: Jul. 20, 2017

(30) Foreign Application Priority Data
Jul. 27, 2016 (IN) 201641025656

(51) Int. Cl. G06F 19/00

(52) U.S. Cl. CPC G06F 19/3418; G06F 19/322

(57) ABSTRACT

The present disclosure relates to the field of clinical care plan for patients. More particularly, the present disclosure relates to a method and system for determining plausibility of clinical care plan. The present disclosure checks for plausibility of the clinical care plan determining plausibility of each clinical action in the action plan. The plausibility of a current clinical action is determined by comparing the quantitative factors and its corresponding quantitative values associated with the current clinical action with the quantitative factors and the corresponding quantitative values of the previous clinical action. In the present disclosure, the effects of previous clinical actions are considered for determining plausibility of the current clinical action and hence provide an effective mechanism for determining plausibility of the overall clinical care plan. The present invention substantially reduces the time for determining plausibility of clinical care plan since it is an automated process.

### FIELD OF THE DISCLOSURE

The present subject matter generally relates to clinical care plan for patients. More particularly, but not exclusively, the present disclosure discloses a method and a system for determining plausibility of a clinical care plan.

### BACKGROUND

Clinical care plans or treatment plans is designed to help in managing treatments, hospital resources and financial aspects of patients. In such a plan, some of the actions may overlap, some actions may have dependencies on other past actions and some of them may be contraindicating with respect to the given patient.

Most of these tasks of identifying dependencies, overlapping and contra indicators in the actions are done manually by medical staff, which depends on his/her skills and knowledge. Further, once the plan is devised it is important to adapt the clinical care plans to each individual. Thus, once the clinical care plan is devised it is important to do plausibility check on the actions present in it. Doing this manually is time consuming and leads to ineffective plans.

The conventional techniques checks for plausibility for each action in the clinical care plans but treats each of the action independently. And also does not associate the actions with the previous action in the plan. Hence, they fail to check for plausibility considering the effect of previous actions that were taken in the care plans before the current action. The effect of the previous action is necessary in analyzing how they would affect the next actions in the plan. Also, in some of the conventional techniques the clinical care plans of a previous patient are used to derive a clinical care plan for a current patient for the similar action. However, the effects the clinical care plan differ from patient to patient and hence those clinical care plans are not effective.

### SUMMARY

Disclosed herein is a method and system for determining plausibility of a clinical care plan. The clinical care plans are retrieved from a care plan document. The clinical care plan comprises of plurality of clinical actions. Each clinical action is associated with quantitative factors and quantitative values which would affect the clinical action and which get affected due to the execution of the clinical action. The quantitative factors and the quantitative values are extracted from health care documents. The quantitative factors and the quantitative values which affect a current clinical action are compared with quantitative factors and the quantitative values which were affected due to the execution of a previous clinical action. Based on the comparison, each clinical action is checked for plausibility and thereafter overall plausibility of the clinical care plan is determined.

Embodiments of the present disclosure disclose a method for determining plausibility of a clinical care plan. The method comprising retrieving, by a care plan indication system, a relevant health care document from a plurality of health care documents and a relevant care plan document from a plurality of care plan documents based on user details, wherein the plurality of care plan documents comprises one or more clinical actions. The method also comprises extracting one or more first quantitative factors affecting each of the one or more clinical actions and corresponding first quantified values and one or more second quantitative factors affected from execution of each of the one or more clinical actions and corresponding second quantified values. Upon retrieving the relevant health care document and the relevant care plan document, each of the one or more first quantitative factors of a current clinical action is compared with each of the one or more second quantitative factors of a previous clinical action. Also, first quantified value corresponding to each of the one or more first quantitative factors of the current clinical action is compared with the second quantified value corresponding to each of the one or more second quantitative factors of the previous clinical action. Further a value from a predefined value is modified when there is match in at least one of the first quantitative factors of the current clinical action and at least one of the second quantitative factors of the previous clinical action and mismatch in the first quantified value and the second quantified value of the matched at least one the first quantitative factors and the second quantitative factors. Upon modifying the value, the plausibility of the current clinical action is detected when a total value is equal to the predefined value, thereby determining the plausibility of the clinical care plan.

Embodiments of the present disclosure disclose a system for determining plausibility of a clinical care plan. The system comprises a processor and memory communicatively coupled to the processor, wherein the memory stores the processor-executable instructions, which, on execution, causes the processor to retrieve a relevant health care document from a plurality of health care documents and a relevant care plan document from a plurality of care plan documents based on user details, wherein the plurality of care plan documents comprises one or more clinical actions. The instructions also causes the processor to extract one or more first quantitative factors affecting each of the one or more clinical actions and corresponding first quantified values and one or more second quantitative factors affected from execution of each of the one or more clinical actions and corresponding second quantified values. Upon retrieving the relevant health care document and the relevant care plan document, the processor compares the one or more first quantitative factors of a current clinical action with each of the one or more second quantitative factors of a previous clinical action. The processor also compares first quantified value corresponding to each of the one or more first quantitative factors of the current clinical action with the second quantified value corresponding to each of the one or more second quantitative factors of the previous clinical action. Thereafter, the processor modifies a value from a predefined value when there is match in at least one of the first quantitative factor of the current clinical action and at least one of the second quantitative factor of the previous clinical action and mismatch in the first quantitative value and the second quantitative value of the matched at least one the first quantitative factor and the second quantitative factor. Further, the processor detects plausibility of the current clinical action when a total value is equal to the predefined value, thereby determining the plausibility of the clinical care plan.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIGS. 1a-1b illustrates exemplary environment for determining plausibility of clinical care plans in accordance with some embodiments of the present disclosure;

FIG. 1c shows exemplary representation of sequence of clinical actions of a clinical care plan in accordance with some embodiments of the present disclosure;

FIG. 2 shows detailed block diagram of a care plan indication system in accordance with some embodiments of the present disclosure;

FIGS. 3a-3b shows exemplary representation of a segment in the clinical care plan and its associated quantitative factors and quantified values in accordance with some embodiments of the present disclosure;

FIG. 4 shows a flowchart illustrating a method for determining plausibility of a clinical care plan in accordance with some embodiments of the present disclosure;

FIG. 5 shows a flowchart illustrating a method for determining availability of alternate clinical actions in accordance with some embodiments of the present disclosure; and

FIG. 6 shows a flowchart illustrating a method for validating the clinical care plan suggested by healthcare professionals in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

As used herein, the term “plausibility” or “plausible” refers to worth of being accepted or believable, the term “clinical care plan” refers to a treatment plan indicated or suggested by any health care unit/health care personnel such as hospitals, clinics, doctors etc., the term “clinical actions” refers to sequence of actions or operations to be performed during the treatment, the term “quantitative factors” either first quantitative factor or second quantitative factor refers to those which quantifies validity of the clinical actions in the clinical care plan for example medical vital status, blood components, effect on body parts (Ex: tumor swelling), hormonal fluids, Enzyme secretions, physiological factors etc.

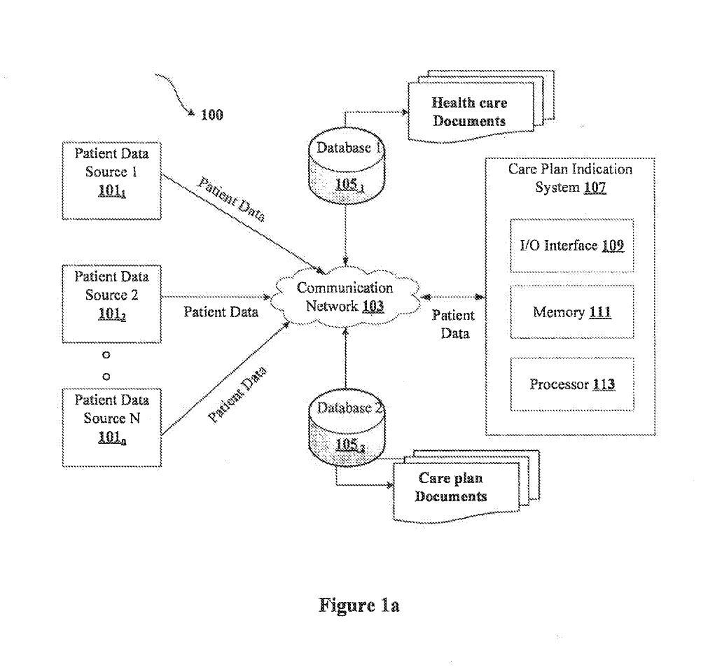

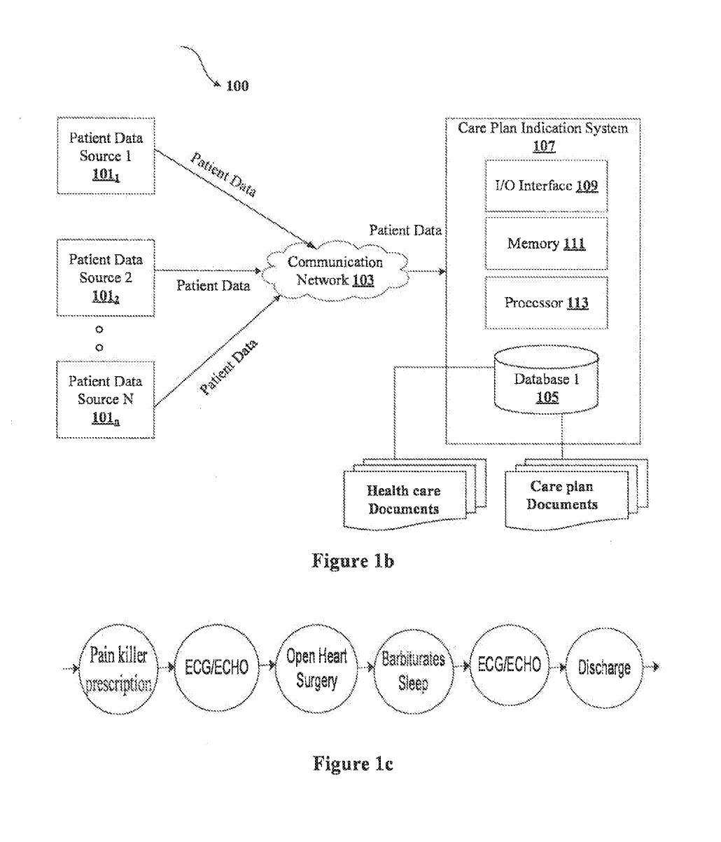

FIGS. 1a-1b illustrates exemplary environment for determining plausibility of clinical care plans in accordance with some exemplary embodiments of the present disclosure. The environment 100 comprises one or more patient data sources, patient data source 1 101₁ to patient data source N 101ₙ (collectively referred as patient data sources 101), a communication network 103, one or more databases for example database 1 105₁ and database 2 105₂ (collectively referred as database/databases 105) and a care plan indication system 107. In an embodiment, the care plan indication system 107 may be configured as a module which may be used by hospitals, clinics or any health care units/health care personnel for determining the plausibility of the clinical care plans. In other embodiment, the care plan indication system 107 may be configured as a separate entity for example as a server and the hospitals or the clinics may be interfaced to avail the services of the care plan indication system 107. The care plan indication system 107 receives user/patient details from the one or more patient data sources 101. The user details comprise personal information and medical information of the user. As an example, the personal details may include, but not limited to name, demography information, contact information, care takers information etc. As an example, the medical information may include allergies of the user, current medical symptoms of the user, previous health history of the user and physiology of the user. The one or more patient data sources 101 may include but not limited to a hospital, a clinic, a health care unit and a communication device associated with the user wherein the user may directly provide the information to the care plan indication system 107. The communication network 103 may be a wired or wireless network.

The care plan indication system 107 is associated with the one or more databases 105. In an exemplary embodiment, the database 1 105₁ stores plurality of health care documents and the database 2 105₂ stores plurality of care plan documents as shown in the FIG. 1a. In an embodiment, there may be a single database 105 for storing both the health care documents and the care plan documents. The databases 105 may be hosted in a cloud environment as shown in FIG. 1a or may be hosted in the care plan indication system 107 itself as shown in FIG. 1b.

The health care documents may include, but not limited to, information related to one or more diseases, related symptoms, corresponding treatments, list of diseases identified and summary of treatment, administrative and billing data, patient demographics, progress notes, vital signs, medical histories, diagnoses, medications, immunization dates, allergies, radiology images, lab and test results. The health care documents also comprise information related to quantitative factors and quantified values associated with each clinical action. The quantitative factors are those which quantify the validity of the clinical action. The care plan documents may comprise information related to one or more clinical care plans suggested/recommended by the health care units/health care personnel. The clinical care plan is a sequence of operation to be performed for treatment of the disease. As an example, the patient may be suffering from a chest pain. The doctor may have suggested a clinical care plan to cure the chest pain. The clinical care plan may comprise one or more actions/operations. The one or more actions in the given clinical care plan may be as shown in FIG. 1c. Each circle in the clinical care plan indicates an action or an operation to be performed.

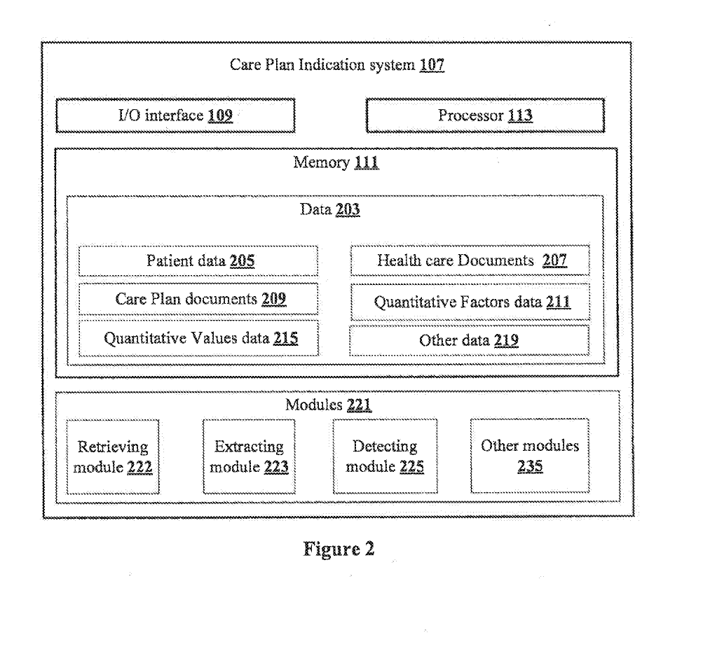

FIG. 2 shows a detailed block diagram of a care plan indication system in accordance with some embodiments of the present disclosure.

The care plan indication system 107 comprises an Input/output (I/O) interface 109, a memory 111 and a processor 113. The I/O interface 109 is configured to provide an interface with the one or more databases 105 and the plurality of patient data sources 101. Through the I/O interface 109, the care plan indication system 107 receives the user data, the health care documents and the care plan documents. In one embodiment, the care plan indication system 107 may retrieve only relevant health care documents and the care plan documents based on the user details i.e only those documents are retrieved which are applicable to the given user based on the details of the user. As an example, the user may be suffering from a chest pain and in the user details, the symptoms of chest pain would have been indicated. In this scenario, the health care document comprising information related to the qualitative factors such as blood sugar, body temperature and its corresponding quantified values would only be extracted. Similarly, the care plan document which comprises a care plan related to the treatment of the disease chest pain would only be retrieved. In another embodiment, all the documents may be retrieved from the databases 105 and later extract only those documents which are relevant for the given user based on the user details. In some other embodiments, the relevant health care documents and the care plan documents may also be provided to the care plan indication system 107 from the health care personnel such as doctors. The retrieved relevant health care document and the care plan documents are stored in the memory 111. The received user details are also stored in the memory 111. The processor 113 determines plausibility of the clinical care plan by determining plausibility of each clinical action in the clinical care plan.

In one implementation, the care plan indication system 107 receives the user data from the one or more patient data sources 101 and receives the health care documents and the care plan documents from the one or more databases 105. In one embodiment, data 203 stored in the memory 111 comprises the patient/user data 205, health care documents 207, care plan documents 209, quantitative factors data 211, quantified values data 215 and other data 219. In the illustrated FIG. 2, modules 221 are described here in detail.

In one embodiment, the data 203 may be stored in the memory 111 in the form of various data structures. Additionally, the aforementioned data can be organized using data models, such as relational or hierarchical data models. The other data 219 may store data, including temporary data and temporary files, generated by modules 221 for performing the various functions of the care plan indication system 107.

In an embodiment, the user data 205 comprises information related to personal details of the user and the medical details of the user. As an example, the personal details may include, but not limited to name, demography information, contact information, care takers information etc. As an example, the medical information may include allergies of the user, current medical records of the user, previous health history of the user and physiology of the user.

In an embodiment, the health care documents 207, may include but not limited to, information related to one or more diseases, symptoms, corresponding treatments list of diseases identified and treated summary of treatment, administrative and billing data, patient demographics, progress notes, vital signs, medical histories, diagnoses, medications, immunization dates, allergies, radiology images, lab and test results. The health care documents 207 also comprise information related to quantitative factors which affect the clinical action and gets affected during execution of the clinical action. The quantitative factors quantify the validity of the clinical actions. The health care documents 207 also comprise information related to quantified values corresponding to each quantitative factor. The quantified values may be one of normal, increased or decreased.

In an embodiment, the care plan documents 209 comprise information related to one or more clinical care plans suggested by the doctors for a particular disease. The clinical care plan may comprise one or more actions/operations.

In an embodiment, the quantitative factors data 211 comprises information of quantitative factors associated with each clinical action in the clinical care plan. The quantitative factors are categorized into first quantitative factors and the second quantitative factors. The first quantitative factors are those which affect the execution of the action and the second quantitative factors are those which get affected due to execution of the clinical action.

In an embodiment, the quantified values data 215 comprises values corresponding to each quantitative factor associated with the clinical action. The quantified values are one of normal, increased and decreased. The normal value is the predefined value which is defined in the health care document and which may vary from one user to another user. The increased and the decreased values are identified with respect to the normal as the base value.

In an embodiment, the data stored in the memory 111 is processed by the modules 221 of the care plan indication system 107. The modules 221 may be stored within the memory 111. In an example, the modules 221, communicatively coupled to the processor 113 configured in the care plan indication system 107, may also be present outside the memory 111 as shown in FIG. 2 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the modules 221 may include, for example retrieving module 222, extracting module 223, detecting module 225 and other modules 235. The other modules 235 may be used to perform various miscellaneous functionalities of the care plan indication system 107. It will be appreciated that such aforementioned modules 221 may be represented as a single module or a combination of different modules 221.

In an embodiment, the retrieving module 222 retrieves a relevant care plan document from a plurality of care plan documents and a relevant health care document from the plurality of health care documents based on the user details. The relevant care plan document comprises one or more clinical actions.

In an embodiment, the extracting module 223 extracts one or more first quantitative factors affecting each of the one or more clinical actions and corresponding first quantified values and one or more second quantitative factors affected from execution of each of the one or more clinical actions and corresponding second quantified values from the relevant health care document. As an example, the quantitative factors and the corresponding quantified values may be extracted using NLP techniques such as numerical attribute extraction.

In an embodiment, the detecting module 225 detects the plausibility of each clinical action in the clinical care plan. The process of detecting the plausibility of each clinical action is described with the help of an example as illustrated below.

### Exemplary Embodiment

Consider an example of a patient visiting the hospital with symptoms of chest pain. One of the clinical care plans (hypothetical) for the treatment of chest pain is as shown in FIG. 1c. Each circle in the clinical care plan represents an action/operation.

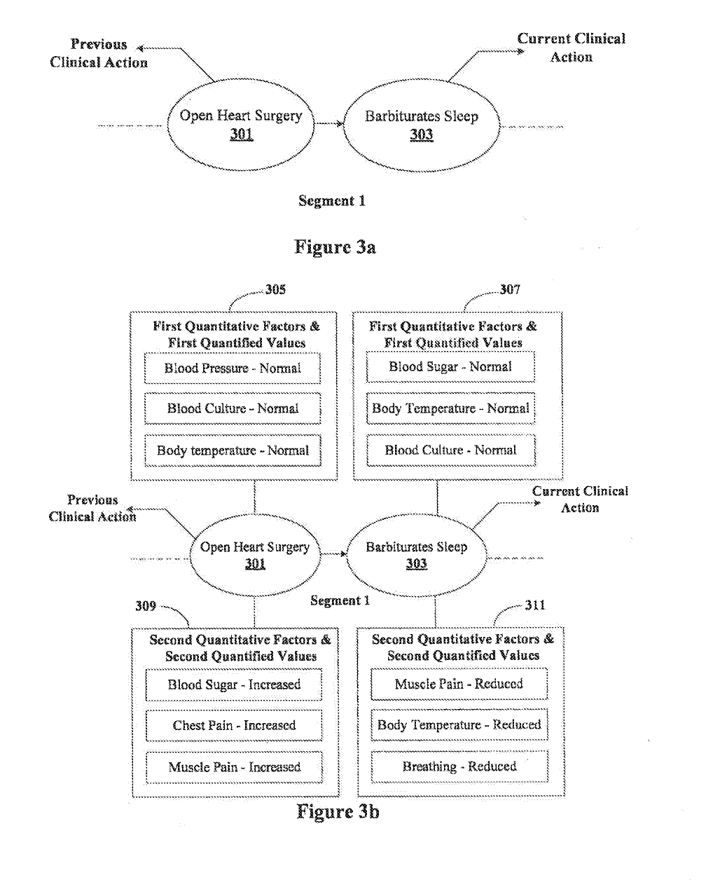

Consider a segment, segment 1 of the clinical care plan as shown in FIG. 3a which contains two actions namely “open heart surgery” 301 and “barbiturates for sleep” 303. The action “barbiturates for sleep” 303 is a current clinical action and the action “Open Heart surgery” 301 is a previous clinical action.

The extracting module 223 extracts the first quantitative factors and the corresponding first quantitative values for the action “open heart surgery” 301 as shown in the below Table 1. The first quantitative factors are the factors which affect the execution of the action “open heart surgery” 301 i.e these factors have to be monitored or should be under control for performing the action “open heart surgery” 301. As an example the first quantitative factors are “blood sugar”, body temperature” and blood culture value”.

TABLE 1

| First Quantitative Factor | First Quantified value |
|---|---|
| Blood Sugar | Normal |
| Body Temperature | Normal |
| Blood Culture | Normal |

Similarly, the extracting module 223 extracts the first quantitative factors and the corresponding first quantified values for the action “Barbiturates for sleep” 303 as shown in the below Table 2. As an example, the first quantitative factors are “blood sugar”, “body temperature” and “blood culture.

TABLE 2

| First Quantitative Factor | First Quantified value |
|---|---|
| Blood Pressure | Normal |
| Blood Culture | Normal |
| Body temperature | Normal |

Further, the extracting module 223 extracts the second quantitative factors and corresponding second quantified values which would get affected by the execution of the action “open heart surgery” 301 i.e these factors may get affected when the open heart surgery is performed. For example, the blood sugar level of the patient may increase or the patient may experience a chest pain or muscle pain etc. Those second quantitative factors and the corresponding second quantified values are as shown in the below Table 3.

TABLE 3

| Second Quantitative Factor | Second Quantified value |
|---|---|
| Blood Sugar | Increased |
| Chest pain | Increased |
| Muscle pain | Increased |

Similarly, the extracting module 223 extracts the second quantitative factors which would get affected by the execution of the action “Barbiturates for sleep” 303. Those second quantitative factors and the corresponding second quantified values are as shown in below Table 4.

TABLE 4

| Second Quantitative Factor | Second Quantified value |
|---|---|
| Muscle pain | Reduced |
| Body Temperature | Reduced |
| Breathing | Reduced |

FIG. 3b shows an exemplary representation of the segment 1 with the list of first quantitative factors and the corresponding first quantified values 305 and 307 associated with the action “open heart surgery” 301 and “barbiturates sleep” respectively and the list of second quantitative factors and the corresponding second quantified values 309 and 311 associated with the action “open heart surgery” 301 and “barbiturates sleep” respectively.

In an embodiment the detecting module 225 compares each of the one or more first quantitative factors of the current clinical action with each of the one or more second quantitative factors of the previous clinical action i.e the detecting module 225 compares each of the one or more first quantitative factors of the current clinical action “Barbiturates for sleep” 303 with each of the one or more second quantitative factors of the previous clinical action “Open heart surgery” 301.

The detecting module 225 also compares the first quantified value corresponding to each of the one or more first quantitative factors of the current clinical action i.e “Barbiturates for sleep” 303 with the second quantified value corresponding to each of the one or more second quantitative factors of the previous clinical action i.e “open heart surgery” 301.

Based on comparison the detecting module 225 modifies a value from a predefined value when there is match in at least one of the first quantitative factors of the current clinical action and at least one of the second quantitative factors of the previous clinical action and mismatch in the first quantified value and the second quantified value of the matched at least one the first quantitative factors and the second quantitative factors. The detecting module 225 may implement matching techniques/algorithms which includes, but not limited to, NLP or semantic analysis, for matching the quantitative factors. It should be understood by those skilled in the art that any other matching technique may be used in the present invention to match the quantitative factors based on which the plausibility of the clinical action would be detected. As an example, the first quantitative factors of the current clinical action may be “blood sugar” “body temperature” and “blood culture” and the second quantitative factors of the previous clinical action may be “blood sugar”, “muscle pain” and “chest pain”. One of the first quantitative factors of the current clinical action i.e “blood sugar” is same as one of the second quantitative factors of the previous clinical action i.e “blood sugar”. Since these factors are same there is a match between these factors. In a similar way, when the quantified values are same then there is a match between the quantified values as well. Further, the term “mismatch” is used when the factors are not same or when the quantified values are not same.

The predefined value may vary from one user to another user. The predefined value as an example may be zero. In a non-limiting embodiment, the predefined value may be any positive integer or a negative integer as well. In each comparison, the value is modified.

In an embodiment, modifying the value comprises one of decrementing or incrementing the value from the predefined value when there is match in at least one of the first quantitative factors of the current clinical action and at least one of the second quantitative factors of the previous clinical action and mismatch in the first quantified value and the second quantified value of the matched at least one the first quantitative factors and the second quantitative factors.

In an embodiment, the predefined value is retained when there is mismatch in at least one of the first quantitative factors of the current clinical action and at least one of the second quantitative factors of the previous clinical action.

In an embodiment, the predefined value is retained when there is match in at least one of the first quantitative factors of the current clinical action and at least one of the second quantitative factors of the previous clinical action and match in the first quantified value and the second quantified value of the matched at least one the first quantitative factors and the second quantitative factors.

The Table 5 below shows the process of comparison of the quantitative factors and the quantified values involved in the segment 1.

| | | Value (predefined Value is |
|---|---|---|
| Step | Comparison | zero) |
| 1 | Increased blood sugar with Normal | Value = −1 |
| | Blood sugar | Contraindication found |
| | | (increased != Normal) |
| | | hence Value is decreased |
| 2 | Increased blood sugar with Normal | Value = −1 (No change) |
| | Body Temperature | (No match in quantitative |
| | | factors) |
| | | (Blood sugar != Body |
| | | temperature) |
| 3 | Increased blood sugar with Normal | Value = −1 (No change) |
| | Blood culture | (No match in quantitative |
| | | factors) |
| | | (Blood sugar != Blood |
| | | culture) |
| 4 | Increased Chest pain with Normal | Value = −1 (No change) |
| | Blood sugar | (No match in quantitative |
| | | factors) |
| 5 | Increased Chest pain with Normal | Value = −1 (No change) |
| | Body Temperature | (No match in quantitative |
| | | factors) |
| 6 | Increased Chest pain with Normal | Value = −1 (No change) |
| | blood culture | (No match in quantitative |
| | | factors) |
| 7 | Increased Muscle Pain with Normal | Value = −1 (No change) |
| | Blood sugar | (No match in quantitative |
| | | factors) |
| 8 | Increased Muscle Pain with Normal | Value = −1 (No change) |
| | Body Temperature | (No match in quantitative |
| | | factors) |
| 9 | Increased Muscle Pain with Normal | Value = −1 (No change) |
| | blood culture | (No match in quantitative |
| | | factors) |

In the “Step 1”, there is match in the quantitative factors but there is mismatch in the quantified values and hence the value is modified. The value may either be incremented or decremented from the predefined value and accordingly the plausibility of the clinical care plan is determined. As an example, in this scenario the value is decremented from the predefined value. The reduced value is “−1”.

In the “Step 2” there is mismatch in the quantitative factors and hence the value is modified. The value is decremented from the predefined value. The reduced value is “−1”.

In the “Step 3” there is mismatch in the quantitative factors and hence the value is modified. The value is decremented from the predefined value. The reduced value is “−1”.

In the “Step 4” there is mismatch in the quantitative factors and hence the value is modified. The value is decremented from the predefined value. The reduced value is “−1”.

In the “Step 5” there is mismatch in the quantitative factors and hence the value is modified. The value is decremented from the predefined value. The reduced value is “−1”.

In the “Step 6” there is mismatch in the quantitative factors and hence the value is modified. The value is decremented from the predefined value. The reduced value is “−1”.

In the “Step 7” there is mismatch in the quantitative factors and hence the value is modified. The value is decremented from the predefined value. The reduced value is “−1”.

In the “Step 8” there is mismatch in the quantitative factors and hence the value is modified. The value is decremented from the predefined value. The reduced value is “−1”.

In the “Step 9” there is mismatch in the quantitative factors and hence the value is modified. The value is decremented from the predefined value. The reduced value is “−1”.

In an embodiment, the detecting module 225 detects plausibility of the current clinical action when a total value is equal to the predefined value. In an embodiment, the total value is determined based on sum of the value identified in each comparison i.e each step. The non-plausibility of the current clinical action is detected when the total value is less than the predefined value or more than the predefined value. In this scenario, the total value is a negative integer. Since the total value is a negative integer, the action “Barbiturates for sleep” is detected as a non-plausible action.

The detecting module 225 detects plausibility of the clinical care plan upon detecting plausibility or non-plausibility of each clinical action in the clinical care plan. If there is even one clinical action which is non-plausible, then the clinical care plan would be determined as non-plausible.

In an embodiment, upon detecting plausibility of the clinical actions, the detecting module 225 checks for availability of alternate clinical actions. If the alternate clinical action is available, the extracting module 223 extracts the alternate clinical action and replaces with the non-plausible clinical action. Thereafter, the detecting module 225 determines plausibility of the alternate clinical action. The process of determining the alternate clinical action and checking for plausibility of the alternate clinical action continues until all the clinical actions in the clinical care plan is plausible so that the clinical care plan is plausible for treating the patient.

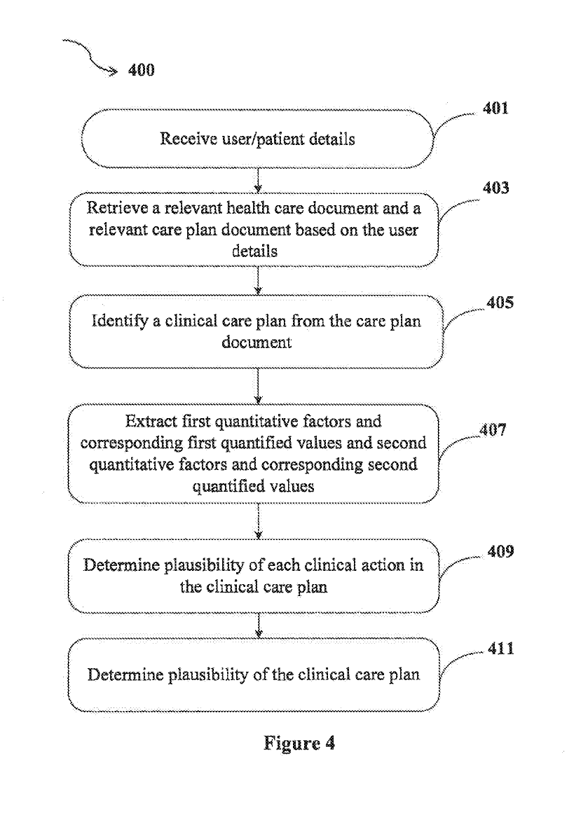

FIG. 4 shows a flowchart illustrating a method for determining plausibility of a clinical care plan in accordance with some embodiments of the present disclosure.

As illustrated in FIG. 4, the method 400 comprises one or more blocks illustrating a method for determining plausibility of a clinical care plan. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the care plan indication system 107 receives user details. The user details comprise personal information and medical information of the user. The user details are received from one or more patient data sources 101. As an example, the patient data source 101 may be a hospital or any health care unit which would provide details of the user for example medical records of the user, previous health details of the user, user name, user address and contact details of the user, information related to care takers of the user etc. The user may also provide the details through a computing device associated with the user such as a mobile phone or a tablet.

At block 403, the care plan indication system 107 retrieves a relevant health care document 207 and a relevant care plan document 209 based on the user details. The care plan document 209 comprises information related to one or more clinical care plans. Each clinical care plan comprises one or more clinical actions. The clinical care plan is basically a treatment plan for treating the user based on the disease identified. The one or more clinical actions are the sequence of actions to be performed for treatment of the disease.

At block 405, the care plan indication system 107 identifies a clinical care plan from the one or more clinical care plans which are best suited for the user.

At block 407, the care plan indication system 107 extracts first quantitative factors and corresponding first quantified values and second quantitative factors and corresponding second quantified values from the relevant health care document 207 for each clinical action in the clinical care plan. The first quantitative factors are those which affect the execution of the clinical action and the second quantitative factors are those which would get affected due to execution of the clinical action. These factors are considered to check the effect of the same on the action and also check the after effects upon execution of the action. Based on this analysis, the doctors may consider changing the actions in the clinical care plan.

At block 409, the care plan indication system 107 determines plausibility of each clinical action in the clinical care plan. The care plan indication system 107 compares each of the one or more first quantitative factors of the current clinical action with each of the one or more second quantitative factors of the previous clinical action. Further, the care plan indication system 107 also compares the first quantified value corresponding to each of the one or more first quantitative factors of the current clinical action with the second quantified value corresponding to each of the one or more second quantitative factors of the previous clinical action.

Based on the comparison, the care plan indication system 107 modifies a value from a predefined value when there is match in at least one of the first quantitative factors of the current clinical action and at least one of the second quantitative factors of the previous clinical action and mismatch in the first quantified value and the second quantified value of the matched at least one the first quantitative factors and the second quantitative factors. Further, the care plan indication system 107 detects plausibility of the current clinical action when a total value is equal to the predefined value. In an embodiment, if the total value is less than the predefined value or more than the predefined value then the clinical action is detected as non-plausible.

At block 411, the care plan indication system 107 determines plausibility of the clinical plan based on plausibility of the clinical actions in the clinical care plan. If all the clinical actions in the clinical care plan are plausible then the clinical care plan is determined as plausible.

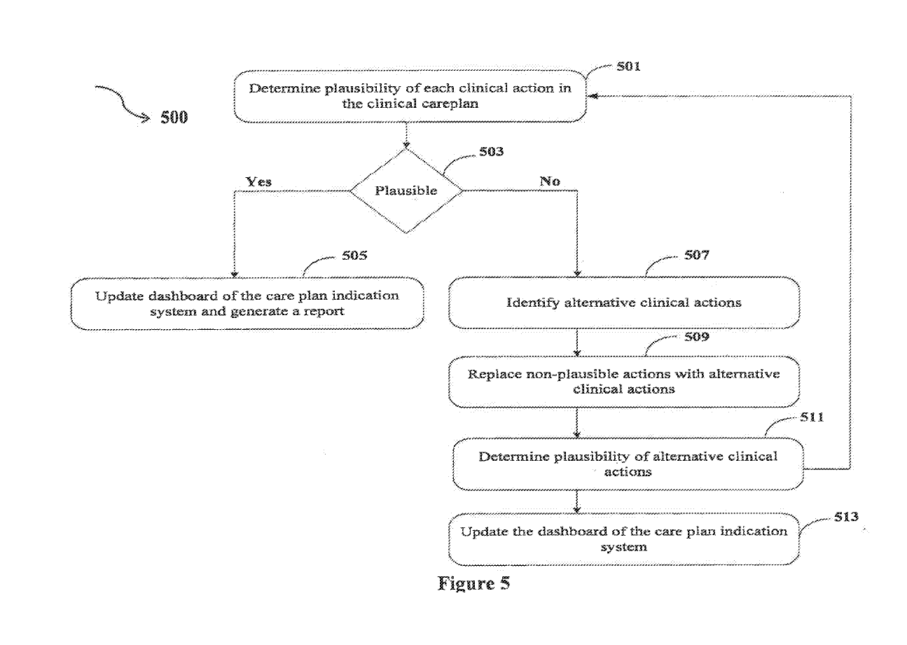

FIG. 5 shows a flowchart illustrating a method for determining availability of alternate clinical actions in accordance with some embodiments of the present disclosure.

As illustrated in FIG. 5, the method 500 comprises one or more blocks illustrating a method for determining availability of alternate clinical actions. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 501, the care plan indication system 107 determines plausibility of each clinical action in the clinical care plan.

At block 503, the care plan indication system 107 detects plausibility of the clinical action and if the clinical action is plausible, then the method proceeds to block 505. If the clinical action is not plausible, then the method proceeds to block 507.

At block 505, the care plan indication system 107 updates its dashboard/display interface which displays list of clinical actions which are plausible. The care plan indication system 107 also generates a report comprising information of the clinical actions which are plausible.

At block 507, the care plan indication system 107 identifies availability of one or more alternate clinical actions from the care plan document.

At block 509, the non-plausible actions are replaced with the available alternate clinical actions.

At block 511, the care plan indication system 107 determines plausibility of the available one or more clinical actions. The plausibility is checked based on the process explained in FIG. 4.

At block 513, the care plan indication system 107 updates the dashboard with the plausible clinical actions if the alternative clinical actions are plausible. If not, then the process of detecting the availability of alternative clinical actions and determining plausibility of the same continues till all the clinical actions in the clinical care plan are plausible.

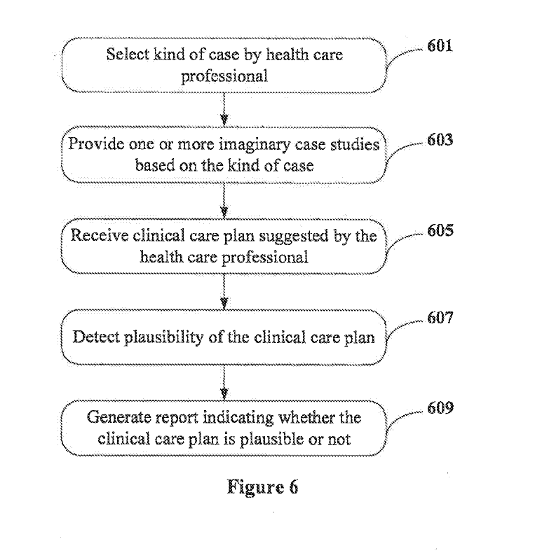

FIG. 6 shows a flowchart illustrating a method for validating the clinical care plan suggested by healthcare professionals in accordance with some embodiments of the present disclosure.

As illustrated in FIG. 6, the method 600 comprises one or more blocks illustrating a method for validating the clinical care plan suggested by healthcare professionals.

At block 601, the health care professional may select kind of cases through the I/O interface 109.

At block 603, the care plan indication system 107 provides one or more exemplary and imaginary case studies based on the type of the case. In an embodiment, the imaginary case studies may be pre-stored in the memory 111 or may be generated dynamically. For example, if the healthcare professional has selected the case related to cancer, then the care plan indication system 107 may provide an exemplary case study of a patient being suffered by severe head ache whose final diagnosis is brain cancer.

At block 605, the care plan indication system 107 receives the clinical care plan suggested by the health care professional which comprises of one or more clinical actions.

At block 607, the care plan indication system 107 detects plausibility of the clinical care plan suggested by the health care professional based on the method illustrated in FIG. 4.

At block 609, the care plan indication system 107 generates a report indicating the one or more actions which are non-plausible and provides the report to the health care professional based on which the health care professional may analyze the error made in suggesting the clinical care plan.

### Advantages of Present Disclosure

Embodiments of the present disclosure provide a method and system for automating the process of determining plausibility of a clinical care plan. Therefore, significantly reduces time.

Embodiments of the present disclosure provide a system for determining the plausibility of the clinical care plan thereby avoiding manual errors.

Embodiments of the present disclosure consider effect of a previous clinical action on the current clinical action in order to check for plausibility of the current clinical action. This way, the plausibility determined for the overall clinical action is more efficient and reliable.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Patient data source |
| 103 | Communication network |
| 105 | Database |
| 107 | Care plan indication system |
| 109 | I/O interface |
| 111 | Memory |
| 113 | Processor |
| 205 | Patient data |
| 207 | Health care documents |
| 209 | Care plan documents |
| 211 | Quantitative factors data |
| 215 | Quantified values data |
| 219 | Other data |
| 222 | Retrieving Module |
| 223 | Extracting Module |
| 225 | Detecting Module |
| 235 | Other Module |
| 301 | Action—open heart surgery |
| 303 | Action—Barbiturates Sleep |
| 305 | First Quantitative factors and first |
| | quantified values for action “Open heart |
| | surgery” |
| 307 | First Quantitative factors and first |
| | quantified values for action |
| | “Barbiturates Sleep” |
| 309 | Second Quantitative factors and second |
| | quantified values for action “Open heart |
| | surgery” |
| 311 | Second Quantitative factors and second |
| | quantified values for action |
| | “Barbiturates Sleep” |

We claim:

1. A method for determining plausibility of a clinical care plan, the method comprising:
retrieving, by a care plan indication system, a relevant health care document from a plurality of health care documents and a relevant care plan document from a plurality of care plan documents based on user details, wherein the plurality of care plan documents comprises one or more clinical actions;
extracting, for each of the one or more clinical actions, by the care plan indication system, one or more first quantitative factors affecting each of the one or more clinical actions and corresponding first quantified values and one or more second quantitative factors affected from execution of each of the one or more clinical actions and corresponding second quantified values;
comparing, by the care plan indication system, each of the one or more first quantitative factors of a current clinical action with each of the one or more second quantitative factors of a previous clinical action;
comparing, by the care plan indication system, the first quantified value corresponding to each of the one or more first quantitative factors of the current clinical action with the second quantified value corresponding to each of the one or more second quantitative factors of the previous clinical action;
modifying, based on comparison, by the care plan indication system, a value from a predefined value when there is match in at least one of the first quantitative factors of the current clinical action and at least one of the second quantitative factors of the previous clinical action and mismatch in the first quantified value and the second quantified value of the matched at least one the first quantitative factors and the second quantitative factors; and
detecting, by the care plan indication system, plausibility of the current clinical action when a total value is equal to the predefined value, thereby determining the plausibility of the clinical care plan.

2. The method as claimed in claim 1, wherein the one or more first quantitative factors and corresponding first quantified values and the one or more second quantitative factors and corresponding second quantified values are extracted from the relevant health care document.

3. The method as claimed in claim 1, wherein the first quantified value and the second quantified value is one of normal, increased and decreased.

4. The method as claimed in claim 1, wherein the plurality of health care documents and the plurality of care plan documents are stored in one or more databases associated with the care plan indication system.

5. The method as claimed in claim 4, wherein the one or more databases are at least one of locally hosted in the care plan indication system and stored in a cloud database.

6. The method as claimed in claim 1, wherein the user details comprises personal information and medical information of the user.

7. The method as claimed in claim 1, wherein non-plausibility of the current clinical action is detected when the total value is less than the predefined value or more than the predefined value.

8. The method as claimed in claim 7 further comprises indicating one or more alternate clinical actions upon detecting the non-plausibility of the current clinical action in the clinical care plan.

9. The method as claimed in claim 8, wherein the clinical care plan is validated for plausibility by checking plausibility of the one or more alternate clinical actions in the clinical care plan.

10. The method as claimed in claim 1, wherein modifying the value comprises one of decrementing or incrementing the value from the predefined value when there is match in at least one of the first quantitative factors of the current clinical action and at least one of the second quantitative factors of the previous clinical action and mismatch in the first quantified value and the second quantified value of the matched at least one the first quantitative factors and the second quantitative factors.

11. The method as claimed in claim 1, wherein the predefined value is retained when there is mismatch in at least one of the first quantitative factors of the current clinical action and at least one of the second quantitative factors of the previous clinical action.

12. The method as claimed in claim 1, wherein the predefined value is retained when there is match in at least one of the first quantitative factors of the current clinical action and at least one of the second quantitative factors of the previous clinical action and match in the first quantified value and the second quantified value of the matched at least one the first quantitative factors and the second quantitative factors.

13. The method as claimed in claim 1, wherein the total value is determined based on sum of the value identified in each comparison.

14. The method as claimed in claim 1, wherein the one or more first quantitative factors and the one or more second quantitative factors quantifies validity of the one or more clinical actions in the clinical care plan.

15. A care plan indication system for determining plausibility of a clinical care plan, the system comprising:
a processor; and
a memory communicatively coupled to the processor, wherein the memory stores the processor-executable instructions, which, on execution, causes the processor to:
retrieve a relevant health care document from a plurality of health care documents and a relevant care plan document from a plurality of care plan documents based on user details, wherein the plurality of care plan documents comprises one or more clinical actions;
extract one or more first quantitative factors affecting each of the one or more clinical actions and corresponding first quantified values and one or more second quantitative factors affected from execution of each of the one or more clinical actions and corresponding second quantified values;
compare the one or more first quantitative actors of a current clinical action with each of the one or more second quantitative factors of a previous clinical action;
compare the first quantified value corresponding to each of the one or more first quantitative factors of the current clinical action with the second quantified value corresponding to each of the one or more second quantitative factors of the previous clinical action;
modify, based on comparison, a value from a predefined value when there is match in at least one of the first quantitative factor of the current clinical action and at least one of the second quantitative factor of the previous clinical action and mismatch in the first quantitative value and the second quantitative value of the matched at least one the first quantitative factor and the second quantitative factor; and
detect plausibility of the current clinical action when a total value is equal to the predefined value, thereby determining the plausibility of the clinical care plan.

16. The care plan indication system as claimed in claim 15, wherein the processor extracts the one or more first quantitative factors and corresponding first quantified values and the one or more second quantitative factors and corresponding second quantified values from the relevant health care document.

17. The care plan indication system as claimed in claim 15, wherein the first quantified value and the second quantified value is one of normal, increased and decreased.

18. The care plan indication system as claimed in claim 15, wherein the plurality of health care documents and the plurality of care plan documents are stored in one or more databases associated with the care plan indication system.

19. The care plan indication system as claimed in claim 18, wherein the one or more databases are at least one of locally hosted in the care plan indication system and stored in a cloud database.

20. The care plan indication system as claimed in claim 15, wherein the processor detects non-plausibility of the current clinical action when the total value is at least one of less than the predefined value or more than the predefined value.

21. The care plan indication system as claimed in claim 20, wherein the processor indicates one or more alternate clinical actions upon detecting the non-plausibility of the current clinical action in the clinical care plan.

22. The care plan indication system as claimed in claim 21, wherein the processor validates the clinical care plan for plausibility by checking plausibility of the one or more alternate clinical actions in the clinical care plan.

23. The care plan indication system as claimed in claim 15, wherein the instructions causes the processor to modify the value by performing one of decrementing or incrementing the value from the predefined value when there is match in at least one of the first quantitative factors of the current clinical action and at least one of the second quantitative factors of the previous clinical action and mismatch in the first quantified value and the second quantified value of the matched at least one the first quantitative factors and the second quantitative factors.

24. The care plan indication system as claimed in claim 15, wherein the processor retains the predefined value when there is mismatch in at least one of the first quantitative factors of the current clinical action and at least one of the second quantitative factors of the previous clinical action.

25. The care plan indication system as claimed in claim 15, wherein the processor retains the predefined value when there is match in at least one of the first quantitative factors of the current clinical action and at least one of the second quantitative factors of the previous clinical action and match in the first quantified value and the second quantified value of the matched at least one the first quantitative factors and the second quantitative factors.

26. The care plan indication system as claimed in claim 15, wherein the one or more first quantitative factors and the one or more second quantitative actors quantifies validity of the one or more clinical actions in the clinical care plan.
